(19) United States
(12) Patent Application Publication
(10) Pub. No.: US 2004/0040354 A1
(43) Pub. Date: Mar. 4, 2004

(54) Shaft locking device

(76) Inventors: Steffen Linkenbach, Eschborn (DE); Oliver Hoffmann, Frankfurt (DE); Jochen Reuss, Hanau (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/399,420

(22) PCT Filed: Oct. 18, 2001
(86) PCT No.: PCT/EP01/12037

(30) Foreign Application Priority Data
Oct. 20, 2000 (DE) 100519709
Sep. 28, 2001 (DE) 101481381

(51) Int. Cl. B60R 25/02

(52) U.S. Cl. 70/186

(57) ABSTRACT

The shaft locking device comprises one or more locking elements which can be at least partially brought into engagement with a recess or opening of the shaft or with a sleeve that encircle the shaft, and which can be axially displaced in the longitudinal direction of the shaft by means of a locking mechanism.

The present invention relates to a shaft locking device, in particular a vehicle steering shaft, by means of which the shaft can be locked thus preventing a turn of the steering wheel and the turn of the steerable vehicle wheels.

Devices for preventing the unauthorized use of vehicles are already known. Most vehicles are therefore provided with a mechanical locking device for the steering system, in which the ignition key provides for the locking and unlocking of the steering system. The ignition key is able to operate an eccentric which is arranged at its end and which causes a sliding element, being pre-tensioned by a spring, to move in axial direction. By means of a projection on the sliding element, a locking gear rim can be brought into engagement with a toothed system of the steering shaft so that the steering system can either be turned freely or become locked.

It is the object of the present invention to create a shaft locking device, in particular for a vehicle steering shaft, having a simple design, but allowing a safe actuation.

The object is achieved by that the locking device comprises one or more locking elements which can be at least partially brought into engagement with a recess or opening of the shaft or with a sleeve that encircles the shaft, and in that the locking elements can be axially displaced in longitudinal direction of the shaft by means of a locking mechanism. The locking device according to the present invention has the advantage that a turning shaft, in particular a steering shaft or steering axle, can be secured with few mechanical components.

The locking elements are preferably ball-shaped.

According to the present invention the locking elements abut on a housing by means of one or more elastic elements.

The above object is also achieved by that the locking device comprises one or more locking elements which can be at least partially brought into engagement with a recess or opening of the shaft or with a sleeve that encircles the shaft and in that the locking elements—in a locked position—can be brought into engagement with a first recess or opening of the shaft or with a sleeve encircling the shaft and—in an unlocked position—with a second recess or opening of the shaft or with a sleeve encircling the shaft.

Preferably, the locking elements—in an unlocked position engage at least partially with a recess or opening, preferably a radial ring groove, extending approximately radially to the shaft.

According to the present invention, the locking elements—in a locked position—engage at least partially into a recess or an opening extending essentially in longitudinal direction of the shaft.

It is provided by the present invention that the locking elements—when the shaft is locked—can be brought from an unlocked position into a locked position by means of an electronic drive or magnet, preferably an electromagnet. In case of electromechanical actuation, preferably by means of an electromagnet, the integration into an electronic immobilising system can be realised in a simple manner. A traditional ignition key with locking cylinder is no longer required for such a system.

According to the present invention several locking elements, preferably three locking elements, are provided and the shaft is—in locked position—is not locked by all locking elements, but preferably only by one locking element.

Preferably the number of recesses or openings exceeds the number of locking elements, in particular three locking elements and five recesses or openings being provided for. Within the meaning of the invention the number of recesses can also be increased in order to increase the resolution.

According to the present invention the locked shaft—at a preset defined moment on the shaft—allows at least a partial rotation of the shaft, preferably a rotation around an angle between 0 and 5°, preferably approx. 1°.

Preferably, the moment on the shaft corresponds to a value between 3 Nm and 300 Nm, preferably approx. 6 Nm.

According to the invention the locking device is intended to serve for locking an electromechanical steering of a vehicle.

Preferably the locking device is provided with an electronic drive, preferably an electromagnet, which is electronically controlled and monitored.

According to the present invention the locking device is integrated into an electronic vehicle immobilising system.

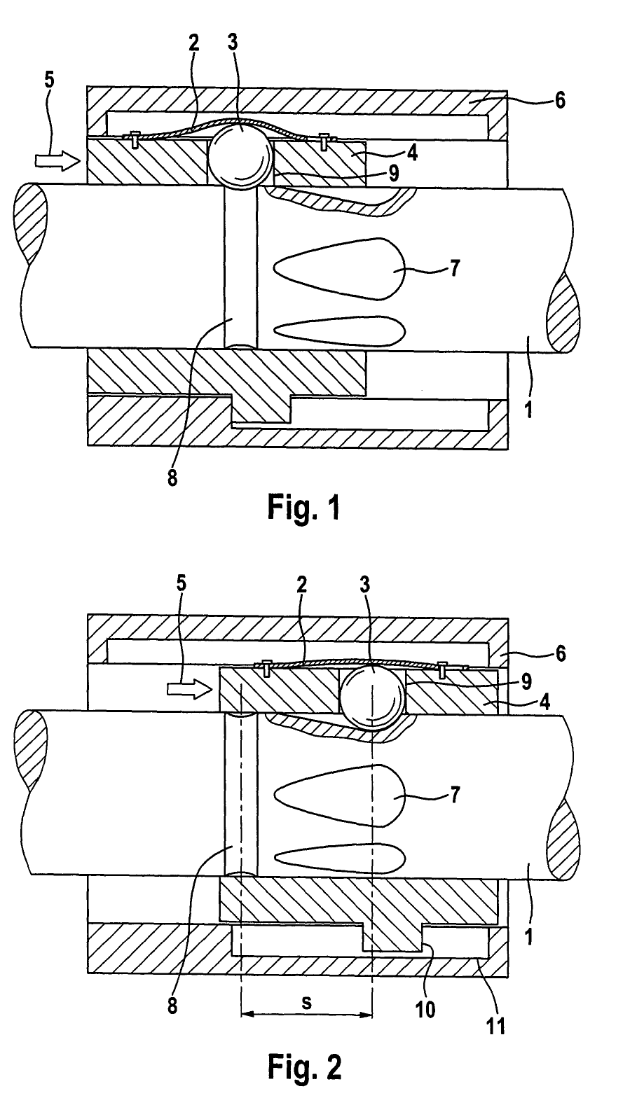

Advantageous embodiments of the locking device according to the present invention are illustrated on the basis of three Figures (FIG. 1 to FIG. 3).

FIG. 1 shows an embodiment of the locking mechanism according to the present invention in a sectional view along a steering axle in an unlocked position.

FIG. 2 shows the locking mechanism of FIG. 1 in a locked position.

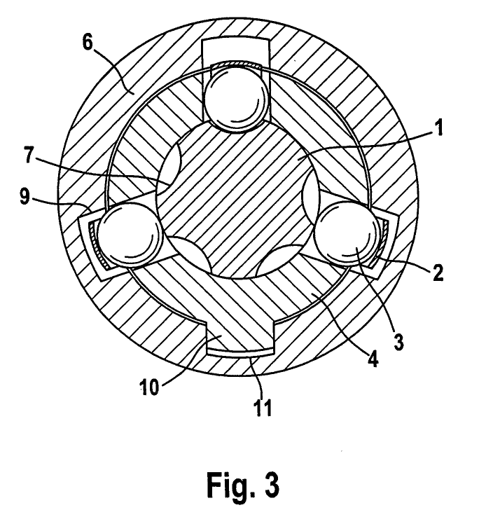

FIG. 3 shows the locking mechanism of FIGS. 1 and 2 in a cross-sectional view.

In the embodiment shown in FIG. 1, the locking mechanism for a turning shaft 1 is provided with elastic elements, in particular spring elements 2, balls 3, a ball retainer 4, a drive, illustrated in this case by an arrow 5, and a housing 6.

The drive, in particular a magnetic drive, is in operative engagement with the ball retainer 4 and the balls 3, the lifting power of the magnetic drive being chosen according to the maximum moment of the locking system. The turning shaft 1 may be e.g. a steering shaft or a steering axle provided with ball tracks 7 and a circumferential groove 8. The ball tracks are formed like ramps and distributed on the circumference of shaft 1. However, a sleeve encircling the shaft in positive engagement and/or in frictional connection can be arranged on shaft 1.

In this case the sleeve is provided—according to the present invention—with a grove and ball tracks and/or ramps (not illustrated). The shaft 1 respectively sleeve is surrounded by the ball retainer 4, encircling the shaft 1 respectively sleeve in a sleeve-type manner. At least one, or preferably at least three radially arranged openings or bores 9 are arranged in ball retainer 4, the openings or bores containing one or more, preferably three balls 3. The ball retainer 4 may be part of a magnet armature or moved by a magnetic drive 5. This magnet should preferably be bi-stable. Thus the energy is advantageously required only for shifting the gears. In both final positions no current conduction is required. Ball retainer 4 is arranged in the housing where it can be displaced axially, but is radially secured against rotation. One or more spring elements 2 abut on ball retainer 4 and press the balls 3 in the direction of the shaft 1.

FIG. 1 illustrates the released position. All balls 3 are positioned in groove 8 and shaft 1 can turn. If the locking system is to be activated, the magnet drive is switched on and the ball retainer 4 causes the balls 3 to move in the direction of the ramps 7 until ball retainer 4 respectively the balls 3 stop after a defined way. The balls 3 are preferably caused to move against the driving direction of the vehicle, so that an undesired locking during abrupt braking is advantageously avoided.

The activated locking is shown in FIGS. 2 and 3, identical elements being given identical reference numerals. The ball retainer 4 respectively the balls 3 remain in their locked final position after a defined path s. The relation between the balls 3 and the ball tracks 7 is such that there is only one position in which a ball is able to roll completely into the ball track. This can be evinced from the cross-sectional view of FIG. 3. In FIG. 3 ball retainer 4 is provided with a projection 10 or a nose-type area which engages into the housing 6 in a groove 11, extending along the shaft 1, and serves as an anti-rotation mechanism.

In case of a locking for a vehicle steering the constructive design of the shaft 1 respectively sleeve, the ball retention 4 and the spring elements 2 is such that the moment being introduced by the steering wheel can be received by the locking mechanism. If the torque of the steering wheel exceeds a certain value, preferably in a range between 3 Nm and 300 Nm, in particular approx. 6 Nm, the ball 3 is pressed out of track 7 and shaft 1 and thus the steering wheel can be turned. It is possible to turn the steering wheel as long as the next ball 3 engages. If the steering wheel torque still exceeds the threshold, the steering wheel may be turned further. In the other case, the steering wheel remains in said position. During operation it might well be possible that a locking of the steering wheel is caused but the balls 3 and the ball tracks 7 on the steering shaft 1 are not positioned so as to fit into each other and thus are not able to engage. But even in such a position it must be possible to lock the steering system in a safe way. In the exceptional case that the balls 3 and the ball tracks 7 do not engage, the balls 3—pre-tensioned by spring 2—adopt a position at the steering shaft 1. When the steering wheel is turned next time in any direction, one ball 3 enters the next ball track 7 of the steering shaft 30.

Ball retainer 4 is caused to move into the initial position shown in FIG. 1 by means of a magnet or a spring element, in order to release the locking. In this case the balls 3 are positioned again in the ring groove 8 maintaining ball retainer 4 in said position by means of the spring elements 2.

The locking device according to the present invention safely avoids a rotation of the shaft 1 up to a certain torque value, but permitting it beyond said torque value. A defined overturning is allowed with technically simple means at a certain steering wheel torque. By arranging the balls 3 to each other, according to the present invention, so that only one ball 3 may be positioned in a ball track 7, there is the further advantage that the release of the locking may be varied by the number of the balls 3 respectively the ball tracks 7. Furthermore the release moment can be defined accurately by the constructive design of the geometries of the ball sleeves and ball retainers in connection with the definition of spring element 2.

According to the present invention said locking mechanism may be arranged several times parallel to each other (with offset). This means that several sleeves encircling shaft 1 and ball retainers 4 are arranged parallel on steering axle 1 thus achieving a very fine grid-type arrangement and increasing the precision of the locking device.

1. Locking device for a shaft, especially a vehicle steering shaft, by means of which the shaft can be locked and thus turning the steering wheel and the steerable vehicle wheels can be prevented,
characterized in that the locking device is provided with one or more locking elements which can be at least partially brought into engagement with a recess or opening of the shaft or with a sleeve encircling the shaft and in that the locking elements can be displaced axially in the longitudinal direction of the shaft by means of a locking mechanism.

2. Locking device according to claim 1,
characterized in that the locking elements have the shape of a ball.

3. Locking device according to claim 1 or 2,
characterized in that the locking elements are supported on a housing by means of one or more elastic elements.

4. Shaft locking device, especially a vehicle steering shaft, by means of which the shaft can be locked and thus turning the steering wheel and the steerable vehicle wheels can be prevented,
characterized in that the locking device is provided with one or more locking elements which can be at least partially brought into engagement with a recess or opening of the shaft or with a sleeve encircling the shaft and in that the locking elements—in a locked position—can be at least partially brought into engagement with a recess or opening of the shaft or with a sleeve encircling the shaft and—in an unlocked position—with a second recess or opening of the shaft or with a sleeve encircling the shaft.

5. Locking device according to any one of the claims 1 to 4,
characterized in that the locking elements—in an unlocked position—engage at least partially into a recess or opening, preferably a radial ring groove, extending approximately in radial direction of the shaft.

6. Locking device according to any one of the claims 1 to 5,
characterized in that the locking elements—in a locked position—engage at least partially into a recess or opening extending essentially along the shaft.

7. Locking device according to any one of the claims 1 to 6,
characterized in that the locking elements can be displaced by means of an electronic drive or magnet, preferably an electromagnet, when the shaft is locked.

8. Locking device according to any one of the claims 1 to 7,
characterized in that several locking elements, preferably three locking elements, are provided and in that—in the locked position—not all the locking elements, but preferably only one locking element locks the shaft.

9. Locking device according to any one of the claims 1 to 8,
characterized in that the number of recesses or openings exceeds the number of locking elements, with especially three locking elements and five recesses or openings being provided.

10. Locking device according to any one of the claims 1 to 9,
characterized in that the locked shaft in case of a preset, defined moment at the shaft allows at least a partial rotational movement of the shaft, preferably a rotation around an angle in the range of 0° to 50, preferably approximately 1°.

11. Locking device according to claim 10,
characterized in that the locked shaft allows at least a partial rotational movement of the shaft in case of a preset, defined moment at the shaft, ranging between 3 Nm and 300 Nm, preferably at approximately 6 Nm.

12. Locking device according to any one of the claims 1 to 11,
characterized in that the locking device is intended for locking an electromechanical steering of a vehicle.

13. Locking device according to any one of the claims 1 to 12,
characterized in that the locking device is provided with an electronic drive, preferably an electromagnet, being electronically controlled and monitored.

14. Locking device according to any one of the claims 1 to 13,
characterized in that the locking device is integrated into an electronic immobilising system of a motor vehicle.
